(19) United States
(12) Patent Application Publication
(10) Pub. No.: US 2011/0202938 A1
(43) Pub. Date: Aug. 18, 2011

(54) Disk Device

(75) Inventors: Kazumasa NASU, Daito-shi (JP); Kazutoshi Takemi, Daito-shi (JP)

(73) Assignee: Funai Electric Co., Ltd., Daito-shi (JP)

(21) Appl. No.: 13/025,616

(22) Filed: Feb. 11, 2011

(30) Foreign Application Priority Data
Feb. 12, 2010 (JP) 2010-28644

(51) Int. Cl. G11B 33/14

(52) U.S. Cl. 720/648; G9B/33.035

(57) ABSTRACT

This disk device includes a rotating portion holding and rotating a disk and a cover member provided to cover a surface of the disk, while the cover member includes a protrusion protruding from a lower surface of the cover member toward the disk, and the protrusion has a substantially sectorial shape including a pair of side portions broadening from a portion closer to a rotation center axis of the rotating portion toward a radial outer side and an outer periphery in plan view.

### BACKGROUND OF THE INVENTION

1. Field of the Invention

The present invention relates to a disk device, and more particularly, it relates to a disk device comprising a rotating part rotating a held disk and a cover member covering the disk held by the rotating part.

2. Description of the Background Art

A disk device comprising a rotating portion rotating a held disk and a cover member covering the disk held by the rotating portion is known in general, as disclosed in Japanese Patent Laying-Open No. 2001-229661, for example.

The aforementioned Japanese Patent Laying-Open No. 2001-229661 discloses a disk drive (disk device) comprising a spindle motor (rotating portion) mountable with a disk and a top cover (cover member) provided to cover a surface of the disk at a prescribed interval from the surface of the disk when mounting the disk on the spindle motor. The top cover of the disk drive according to the aforementioned Japanese Patent Laying-Open No. 2001-229661 has slender (rectangular) protrusions each extending from a portion closer to a rotation center axis of the spindle motor toward the radial outer side in plan view. These protrusions have a function of inhibiting pressure (atmospheric pressure) from decrease in the vicinities of the protrusions between the disk and the top cover. Thus, the disk drive according to the aforementioned Japanese Patent Laying-Open No. 2001-229661 is capable of inhibiting application of flying force to the disk due to reduced pressure between the disk and the top cover.

In the disk drive (disk device) according to the aforementioned Japanese Patent Laying-Open No. 2001-229661, however, the shape of each of the protrusions is slender, and hence a surface area of a surface of each of the protrusions opposed to the disk is small. Therefore, it is conceivably impossible to sufficiently inhibit pressure (atmospheric pressure) from decrease between the disk and the top cover. Consequently, it is conceivably disadvantageously impossible to effectively inhibit application of flying force to the disk.

### SUMMARY OF THE INVENTION

The present invention has been proposed in order to solve the aforementioned problems, and an object of the present invention is to provide a disk device capable of effectively inhibiting application of flying force to a disk.

A disk device according to an aspect of the present invention comprises a rotating portion holding a disk and rotating the held disk and a cover member provided to cover a surface of the disk at a prescribed interval from the surface of the disk when the disk is held by the rotating portion, wherein the cover member includes a protrusion protruding from a lower surface of the cover member toward the disk, and the protrusion has a substantially sectorial shape including a pair of side portions broadening from a portion closer to a rotation center axis of the rotating portion toward a radial outer side and an outer periphery in plan view.

In the disk device according the aspect, as hereinabove described, the protrusion protruding from the lower surface of the cover member toward the disk is provided on the cover member and has a substantially sectorial shape including the pair of side portions broadening from the portion closer to the rotation center axis of the rotating portion toward the radial outer side and the outer periphery in plan view, whereby a surface area of the protrusion can be easily increased, dissimilarly to a case where the shape of the protrusion is slender. Further, the outer periphery of the substantially sectorial shape is protrudable. Thus, pressure between the surface of the disk and the lower surface of the cover member can be effectively inhibited from decrease, and hence application of flying force to the disk can be effectively inhibited. It has been confirmed from a simulation made by the inventors described later that application of flying force to the disk can be effectively inhibited.

In the aforementioned disk device according to the aspect, the protrusion is preferably formed to incline with respect to the surface of the disk by changing a thickness protruding from the lower surface of the cover member toward the disk along a rotation direction of the rotating portion. According to this structure, flow of air rotated together with the disk can be changed in a case of rotating the disk due to the protrusion inclining with respect to the surface of the disk. Thus, flow of air between the surface of the disk and the lower surface of the cover member can be inhibited from acceleration, and hence pressure resulting from acceleration of the flow of the air between the surface of the disk and the lower surface of the cover member can be inhibited from decrease.

In this case, the protrusion is preferably formed to incline by slowly changing the thickness protruding from the lower surface of the cover member toward the disk along the rotation direction of the rotating portion. According to this structure, the flow of the air rotated together with the disk can be inhibited from being excessively turbulent in a case of rotating the disk due to the protrusion inclining by slowly changing the thickness.

In the aforementioned structure having the protrusion inclining by slowly changing the thickness protruding toward the disk, the protrusion is preferably so inclined that the thickness protruding from the lower surface of the cover member toward the disk is gradually reduced along the rotation direction of the rotating portion. According to this structure, application of flying force to the disk can be further inhibited as compared with the structure in which the protrusion is so inclined that the thickness protruding from the lower surface of the cover member toward the disk is gradually reduced along a direction opposite to the rotation direction of the rotating portion. It has been confirmed from a simulation made by the inventors described later that application of flying force to the disk can be further inhibited.

In the aforementioned structure having the protrusion with the thickness protruding toward the disk, gradually reduced along the rotation direction of the rotating portion, the protrusion preferably has a wall portion formed on a side portion in a direction opposite to the rotation direction of the rotating portion and an inclined portion with a thickness protruding toward the disk which becomes smaller as it goes in the rotation direction of the rotating portion centering on the rotation center axis from the wall portion. According to this structure, the flow of the air rotated together with the disk can be caused to collide with the wall portion of the protrusion in a case of rotating the disk, and hence the flow of the air can be slowed in the vicinity of the wall portion. Thus, the pressure resulting from acceleration of the flow of the air between the surface of the disk and the lower surface of the cover member in the vicinity of the wall portion can be more effectively inhibited from decrease.

In this case, the wall portion is preferably formed to extend in a direction substantially perpendicular to the surface of the disk. According to this structure, the flow of the air rotated together with the disk can be easily caused to collide with the wall portion extending in the direction substantially perpendicular to the surface of the disk in a case of rotating the disk, and hence the flow of the air can be easily slowed in the vicinity of the wall portion.

In the aforementioned structure having the protrusion with the wall portion and the inclined portion, a side portion of the inclined portion of the protrusion in the rotation direction of the rotating portion is preferably formed to coincide with a plane of the lower surface of the cover member. According to this structure, no step is formed on a boundary region between the side portion of the inclined portion of the protrusion in the rotation direction of the rotating portion and the plane of the lower surface of the cover member, and hence air colliding with the wall portion of the protrusion adjacent in the rotation direction of the disk can be smoothly moved from the side portion with no step in the rotation direction along the inclined portion in the direction opposite to the rotation direction of the disk. Thus, the flow of the air in the vicinity of the disk can be inhibited from acceleration due to the air moved in the direction opposite to the rotation direction of the disk.

In the aforementioned structure having the protrusion inclining by slowly changing the thickness protruding toward the disk, the protrusion is preferably so inclined that the thickness protruding from the lower surface of the cover member toward the disk is gradually increased along the rotation direction of the rotating portion. According to this structure, a difference between high pressure and low pressure on the surface of the disk can be inhibited from increase as compared with the structure in which the protrusion is so inclined that the thickness protruding from the lower surface of the cover member toward the disk is gradually reduced along the rotation direction of the rotating portion. It has been confirmed from a simulation made by the inventors described later that the difference between the high pressure and the low pressure on the surface of the disk can be inhibited from increase.

In the aforementioned disk device according to the aspect, a plurality of the protrusions are preferably provided, and the plurality of protrusions are preferably arranged centrosymmetrically with the rotation center axis of the rotating portion at a center in plan view. According to this structure, the pressure between the surface of the disk and the lower surface of the cover member can be equally inhibited from decrease in the centrosymmetric portion due to the plurality of protrusions arranged centrosymmetrically with the rotation center axis of the rotating portion at the center.

In this case, the plurality of protrusions are preferably provided at a prescribed interval from each other, and a width of each of the protrusions in a rotation direction of the rotating portion centering on the rotation center axis of the rotating portion is preferably larger than the prescribed interval at the same radial position. According to this structure, the surface area of each of the protrusions can be easily further increased.

In the aforementioned structure having the protrusions provided at the prescribed interval, the width of each of the protrusions in the rotation direction of the rotating portion centering on the rotation center axis of the rotating portion is preferably at least twice the prescribed interval at the same radial position. According to this structure, the surface area of each of the protrusions can be more easily increased.

In the aforementioned disk device according to the aspect, the cover member preferably further includes an annular protrusion protruding from the lower surface of the cover member toward the disk, the annular protrusion preferably has an annular shape centering on the rotation center axis of the rotating portion, and the substantially sectorial protrusion is preferably formed to have a shape obtained by removing the annular protrusion and a portion in the vicinity of the annular protrusion from a sector broadening toward the radial outer side centering on the rotation center axis of the rotating portion in plan view. According to this structure, the protrusion is protrudable on a portion corresponding to a surface of the disk from which a hole is removed in the vicinity of the rotation center axis in a case where the rotated disk is a disk having the hole in the vicinity of the rotation center axis, for example, and hence the protrusion is efficiently protrudable on the portion corresponding to the surface of the disk from which the hole is removed in the vicinity of the rotation center axis while increasing the surface area of the protrusion.

In this case, the annular protrusion may have a thickness larger than that of the substantially sectorial protrusion.

In the aforementioned structure having the protrusion with the wall portion and the inclined portion, the wall portion of the protrusion preferably has a height at least half a distance between the lower surface of the cover member and the surface of the disk in a thickness direction of the protrusion. According to this structure, the flow of the air rotated together with the disk can be easily caused to collide with the wall portion in a case of rotating the disk, and hence the flow of the air can be more easily slowed in the vicinity of the wall portion.

In the aforementioned disk device according to the aspect, the protrusion is preferably integrally formed on the cover member. According to this structure, the number of components can be inhibited from increase.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view for illustrating the structure of a disk device according to a first embodiment of the present invention;

FIG. 2 is a perspective view for illustrating the structure of a top cover of the disk device shown in FIG. 1;

FIG. 3 is a plan view for illustrating the structure of the top cover of the disk device shown in FIG. 1;

FIG. 4 is a sectional view taken along the line 200-200 in FIG. 3;

FIG. 5 is a perspective view for illustrating the structure of a top cover of a disk device according to a second embodiment of the present invention;

FIG. 6 is a sectional view taken along the line 300-300 in FIG. 3 for illustrating a simulation of flow of air in the vicinity of an optical disk when rotating the optical disk;

FIG. 7 is a perspective view showing the structure of a top cover of a disk device according to a comparative example of the present invention;

FIG. 8 is a diagram showing a distribution of pressure in the vicinity of an upper surface of an optical disk in a case where a model of a top cover according to a first example of the present invention is employed;

FIG. 9 is a diagram showing a distribution of pressure in the vicinity of an upper surface of an optical disk in a case where a model of a top cover according to a second example of the present invention is employed; and

FIG. 10 is a diagram showing a distribution of pressure in the vicinity of an upper surface of an optical disk in a case where a model of the top cover according to the comparative example of the first and second examples of the present invention is employed.

### DESCRIPTION OF THE PREFERRED EMBODIMENTS

Embodiments of the present invention are now described with reference to the drawings.

### First Embodiment

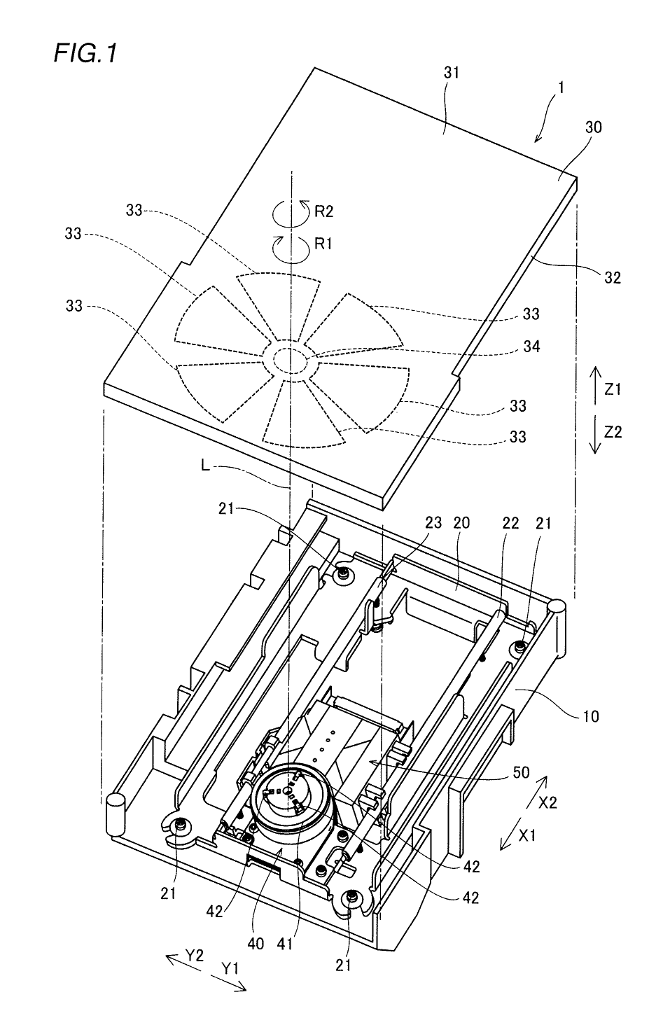

The structure of an optical disk device 1 according to a first embodiment of the present invention is described with reference to FIGS. 1 to 4. According to the first embodiment, the optical disk device 1 is an example of the “disk device” in the present invention.

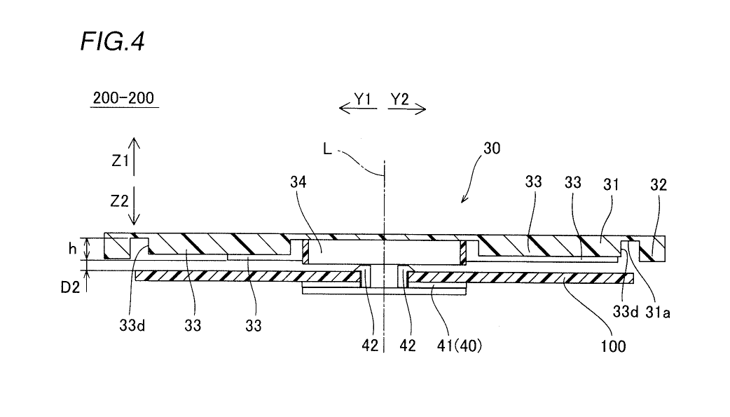

As shown in FIG. 1, the optical disk device 1 according to the first embodiment of the present invention comprises a lower frame 10, a chassis 20 stored in the lower frame 10 and a top cover 30 of resin arrangeable to cover the lower frame 10. The top cover 30 is an example of the “cover member” in the present invention. The optical disk device 1 further comprises a disk rotating portion 40 fixed onto the chassis 20 and an optical pickup portion 50 reading data stored in an optical disk 100 (see FIG. 4) such as a DVD or a blu-ray disc, provided on a side portion of the disk rotating portion 40. The disk rotating portion 40 is an example of the “rotating portion” in the present invention.

The lower frame 10 is formed to be open at the top. The chassis 20 is fixed onto the lower frame 10 with a plurality of screw members 21. The chassis 20 is formed of a sheet metal. A pair of guide shafts 22 and 23 are fixed on an upper side of this chassis 20 along a longitudinal direction (directions X1 and X2) of the chassis 20. The pair of guide shafts 22 and 23 are engaged with the optical pickup portion 50 movably in the directions X1 and X2 along the guide shafts 22 and 23.

The disk rotating portion 40 fixed onto the chassis 20 is formed to be capable of holding the optical disk 100 (see FIG. 4). The disk rotating portion 40 is formed to be capable of rotating the optical disk 100 in a direction R1 around a rotation center axis L when holding the optical disk 100. More specifically, the disk rotating portion 40 includes a disk receiving portion 41 capable of receiving the optical disk 100 and chuck portions 42 for engaging the received optical disk 100. The disk receiving portion 41 and the chuck portions 42 are formed to be rotatable in the direction R1 around the rotation center axis L. The disk receiving portion 41 is formed to come into surface contact with a surface of the optical disk 100 on a reading side and to hold the optical disk 100 in a stable state by bringing the surface of the optical disk 100 into close contact with the disk receiving portion 41 also when rotating the optical disk 100. The chuck portions 42 are formed to engage the optical disk 100 received by the disk receiving portion 41 in a state of being urged toward the disk receiving portion 41 (in a direction Z2). Thus, the chuck portions 42 can inhibit the optical disk 100 from separation from the disk rotating portion 40 also when generating flying force on the optical disk 100 in a case of rotating the optical disk 100.

The optical pickup portion 50 is formed to record/reproduce the optical disk 100 by applying a laser beam to the surface (reading side) of the optical disk 100 (see FIG. 4) mounted on the disk rotating portion 40. The optical pickup portion 50 is moved in the directions X1 and X2 along the guide shafts 22 and 23, whereby the optical pickup portion 5 can be moved to an appropriate position of the reading side of the rotated optical disk 100 and apply a laser beam to an appropriate portion of the reading side of the rotated optical disk 100.

The top cover 30 includes a flat plate portion 31 covering the top of the lower frame 10 and a sidewall portion 32 for fitting the top cover 30 into the lower frame 10.

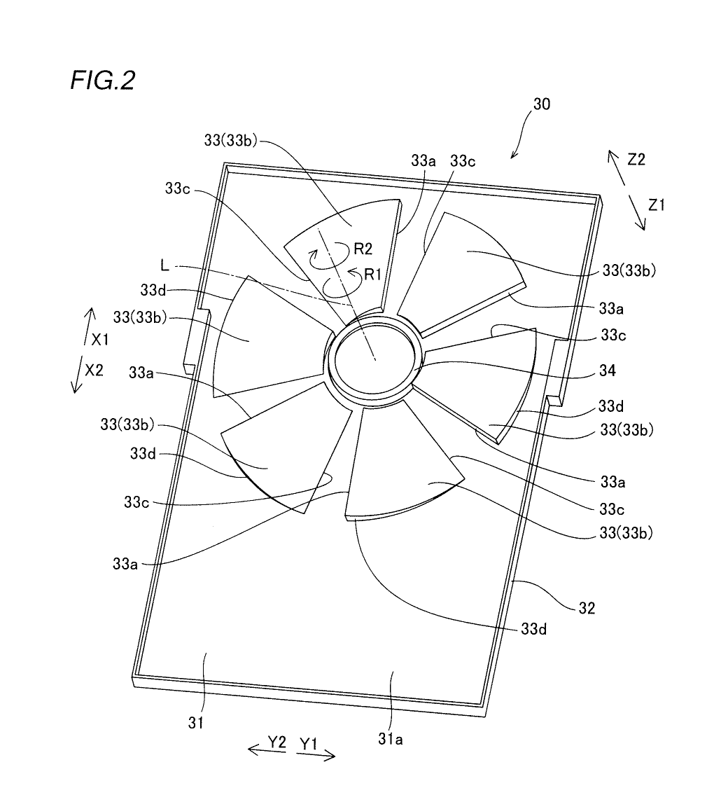

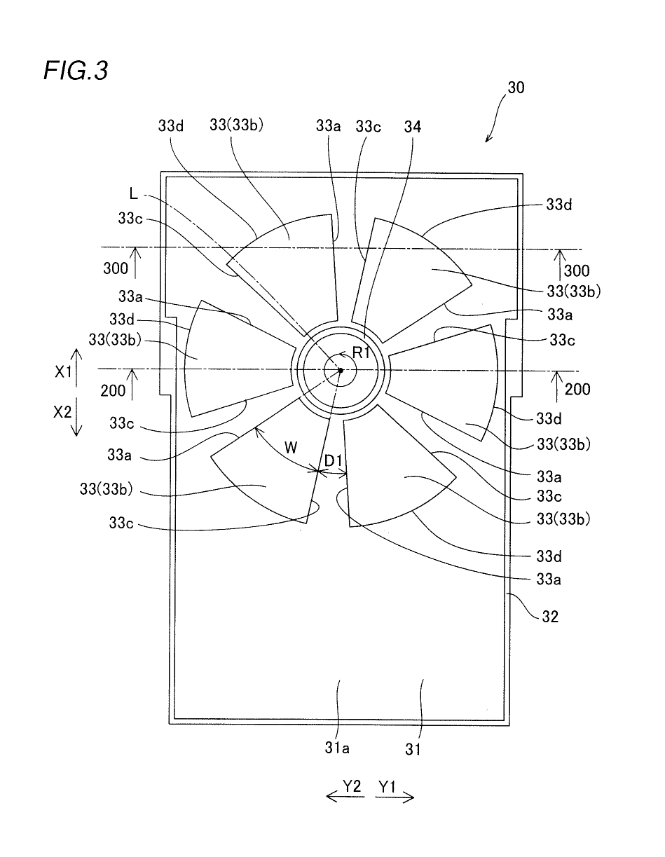

According to the first embodiment, as shown in FIGS. 2 and 3, a plurality of (six) protrusions 33 and a single annular protrusion 34 centering on the rotation center axis L are integrally formed on the flat plate portion 31 of the top cover 30. These protrusions 33 and the annular protrusion 34 are provided on portions of the flat plate portion 31 opposed to an upper surface (in a direction Z1) of the optical disk 100 mounted on the disk rotating portion 40 in a case where the top cover 30 is fitted into the lower frame 10. As shown in FIG. 4, the annular protrusion 34 has a thickness larger than that of each of the protrusions 33 and is provided to protrude from the lower surface 31a of the flat plate portion 31 toward the disk rotating portion 40 (optical disk 100) (in the direction Z2).

According to the first embodiment, as shown in FIGS. 2 and 4, the plurality of (six) protrusions 33 each are formed to protrude toward the disk rotating portion 40 (optical disk 100) (in the direction Z2) from a lower surface 31a of the flat plate portion 31. As shown in FIG. 3, the plurality of (six) protrusions 33 each have a substantially sectorial shape including a pair of side portions broadening from a portion closer to the rotation center axis L of the disk rotating portion 40 toward the radial outer side and an outer periphery in plan view. More specifically, the plurality of (six) protrusions 33 each are formed by removing the annular protrusion 34 and a portion in the vicinity of the annular protrusion 34 from a sector broadening toward the radial outer side centering on the rotation center axis L of the disk rotating portion 40 in plan view.

The plurality of (six) protrusions 33 are arranged centrosymmetrically with the rotation center axis L of the disk rotating portion 40 at the center in plan view. The adjacent protrusions 33 are provided at a constant interval D1. A width W of each of the protrusions 33 in a rotation direction of the disk rotating portion 40 is rendered larger than the aforementioned constant interval D1 at the same radial position. More specifically, the protrusions 33 each have the width W at least twice the aforementioned constant interval D1 at the same radial position in the rotation direction of the disk rotating portion 40.

According to the first embodiment, as shown in FIG. 2, the plurality of (six) protrusions 33 each are formed to incline by slowly changing the thickness protruding from the lower surface 31a of the flat plate portion 31 toward the optical disk 100 (in the direction Z2) along the rotation direction R1 of the disk rotating portion 40. More specifically, the protrusions 33 each include a wall portion 33a formed on a side portion in a direction R2 opposite to the rotation direction R1 of the disk rotating portion 40, an inclined portion 33b with a thickness protruding toward the optical disk 100 (in the direction Z2) which becomes smaller as it goes in the rotation direction R1 of the disk rotating portion 40 centering on the rotation center axis L from the wall portion 33a, an end 33c formed on a side portion of the inclined portion 33b in the direction R1 of the disk rotating portion 40 and an outer periphery 33d corresponding to an arc of the sector. In other words, the protrusions 33 each are formed to incline by reducing the thickness protruding from the lower surface 31a of the flat plate portion 31 toward the optical disk 100 (in the direction Z2) along the rotation direction R1 of the disk rotating portion 40. The wall portion 33a and the end 33c are examples of the “side portion” in the present invention.

The wall portion 33a of each of the protrusions 33 is formed to extend in a direction substantially perpendicular to the flat plate portion 31 from the lower surface 31a of the flat plate portion 31 of the top cover 30. In other words, the wall portion 33a is formed to be substantially perpendicular to the direction R1 of flow of air rotated together with the optical disk 100 rotated by the disk rotating portion 40. Thus, flow in a portion corresponding to the wall portion 33a, of the flow of the air rotated together with the optical disk 100 can be blocked, and hence the flow in the portion corresponding to the wall portion 33a, of the flow of the air rotated together with the optical disk 100 can be inhibited from acceleration. Consequently, pressure resulting from acceleration of flow of air between the surface of the optical disk 100 and the lower surface 31a of the flat plate portion 31 of the top cover 30 can be inhibited from decrease. A height h (see FIG. 4) of the wall portion 33a is about 4 mm. An interval D2 between the wall portion 33a and the surface of the optical disk 100 is about 2 mm.

The inclined portion 33b of each of the protrusions 33 is formed to connect an end of the wall portion 33a closer to the optical disk 100 (in the direction Z2) and the flat plate portion 31 with each other. The end 33c of each of the protrusions 33 is formed to coincide with a plane of the lower surface 31a of the flat plate portion 31 of the top cover 30.

The outer periphery 33d of each of the protrusions 33 is formed to extend arcuately centering on the rotation center axis L in plan view and extend in the direction substantially perpendicular to the flat plate portion 31 from the lower surface 31a of the flat plate portion 31 of the top cover 30. A height of the outer periphery 33d in the direction Z2 lowers along the rotation direction R1 of the disk rotating portion 40, similarly to inclination of the inclined portion 33b.

According to the first embodiment, as hereinabove described, the protrusions 33 protruding from the lower surface 31a of the flat plate portion 31 of the top cover 30 toward the optical disk 100 are provided on the top cover 30 and the protrusions 33 each are formed to have a substantially sectorial shape including the pair of side portions (the wall portion 33a and the end 33c) broadening from the portion closer to the rotation center axis L of the disk rotating portion 40 toward the radial outer side and the outer periphery 33d in plan view, whereby a surface area of each of the protrusions 33 can be easily increased, dissimilarly to a case where the shape of each of the protrusions 33 is slender. Further, the outer periphery 33d of the substantially sectorial shape is protrudable. Thus, pressure between the upper surface (in the direction Z1) of the optical disk 100 and the lower surface 31a of the flat plate portion 31 of the top cover 30 can be effectively inhibited from decrease, and hence application of flying force to the optical disk 100 can be effectively inhibited. It has been confirmed from a simulation made by the inventors described later that application of flying force to the optical disk 100 can be effectively inhibited.

According to the first embodiment, as hereinabove described, the protrusions 33 each are formed to incline with respect to the upper surface (in the direction Z1) of the optical disk 100 by changing the thickness protruding from the lower surface 31a of the flat plate portion 31 of the top cover 30 toward the optical disk 100 (in the direction Z2) along the rotation direction R1 of the disk rotating portion 40, whereby the flow of the air rotated together with the optical disk 100 can be changed in a case of rotating the optical disk 100. Thus, the flow of the air between the upper surface (in the direction Z1) of the optical disk 100 and the lower surface 31a of the flat plate portion 31 of the top cover 30 can be inhibited from acceleration, and hence the pressure resulting from acceleration of the flow of the air between the upper surface (in the direction Z1) of the optical disk 100 and the lower surface 31a of the flat plate portion 31 of the top cover 30 can be inhibited from decrease.

According to the first embodiment, as hereinabove described, the protrusions 33 each are formed to incline by slowly changing the thickness protruding from the lower surface 31a of the flat plate portion 31 of the top cover 30 toward the optical disk 100 (in the direction Z2) along the rotation direction R1 of the disk rotating portion 40, whereby the flow of the air rotated together with the optical disk 100 can be inhibited from being excessively turbulent in a case of rotating the optical disk 100.

According to the first embodiment, as hereinabove described, the protrusions 33 each are so inclined that the thickness protruding from the lower surface 31a of the flat plate portion 31 of the top cover 30 toward the optical disk 100 (in the direction Z2) is gradually reduced along the rotation direction R1 of the disk rotating portion 40, whereby application of flying force to the optical disk 100 can be further inhibited as compared with the structure in which the protrusions 33 each are so inclined that the thickness protruding from the lower surface 31a of the flat plate portion 31 of the top cover 30 toward the optical disk 100 (in the direction Z2) is gradually reduced along the direction R2 opposite to the rotation direction R1 of the disk rotating portion 40. It has been confirmed from a simulation made by the inventors described later that application of flying force to the optical disk 100 can be further inhibited.

According to the first embodiment, as hereinabove described, the wall portion 33a formed on the side portion in the direction R2 opposite to the rotation direction R1 of the disk rotating portion 40 and the inclined portion 33b with a thickness protruding toward the optical disk 100 (in the direction Z2) which becomes smaller as it goes in the rotation direction R1 of the disk rotating portion 40 centering on the rotation center axis L from the wall portion 33a are provided on each of the protrusions 33, whereby the flow of the air rotated together with the optical disk 100 can be caused to collide with the wall portion 33a of each of the protrusions 33 in a case of rotating the optical disk 100, and hence the flow of the air can be slowed in the vicinity of the wall portion 33a. Thus, the pressure resulting from acceleration of the flow of the air between the upper surface (in the direction Z1) of the optical disk 100 and the lower surface 31a of the flat plate portion 31 of the top cover 30 in the vicinity of the wall portion 33a can be more effectively inhibited from decrease.

According to the first embodiment, as hereinabove described, the wall portion 33a is formed to extend in a direction (direction Z2) substantially perpendicular to the upper surface (in the direction Z1) of the optical disk 100, whereby the flow of the air rotated together with the optical disk 100 can be easily caused to collide with the wall portion 33a extending in the direction substantially perpendicular to the upper surface (in the direction Z1) of the optical disk 100 in a case of rotating the optical disk 100, and hence the flow of the air can be easily slowed in the vicinity of the wall portion 33a.

According to the first embodiment, as hereinabove described, the end 33c on the side portion of the inclined portion 33b of each of the protrusions 33 in the rotation direction R1 of the disk rotating portion 40 is formed to coincide with the plane of the lower surface 31a of the flat plate portion 31 of the top cover 30, whereby no step is formed on a boundary region between the end 33c of the inclined portion 33b of each of the protrusions 33 in the rotation direction R1 of the disk rotating portion 40 and the plane of the lower surface 31a of the flat plate portion 31 of the top cover 30, and hence air colliding with the wall portion 33a of each of the protrusions 33 adjacent in the rotation direction R1 of the optical disk 100 can be smoothly moved from the end 33c with no step in the rotation direction R1 along the inclined portion 33b in the direction R2 opposite to the rotation direction R1 of the optical disk 100. Thus, the flow of the air in the vicinity of the optical disk 100 can be inhibited from acceleration due to the air moved in the direction R2 opposite to the rotation direction R1 of the optical disk 100.

According to the first embodiment, as hereinabove described, the plurality of (six) protrusions 33 are arranged centrosymmetrically with the rotation center axis L of the disk rotating portion 40 at the center in plan view, whereby the pressure between the upper surface (in the direction Z1) of the optical disk 100 and the lower surface 31a of the flat plate portion 31 of the top cover 30 can be equally inhibited from decrease in the centrosymmetric portion.

According to the first embodiment, as hereinabove described, the protrusions 33 each are so formed that the width W thereof in the rotation direction R1 of the disk rotating portion 40 centering on the rotation center axis L of the disk rotating portion 40 is larger than the prescribed interval D1 at the same radial position, whereby a surface area of the inclined portion 33b of each of the protrusions 33 can be easily further increased.

According to the first embodiment, as hereinabove described, the protrusions 33 each are so formed that the width W thereof in the rotation direction R1 of the disk rotating portion 40 centering on the rotation center axis L of the disk rotating portion 40 is least twice the prescribed interval D1 at the same radial position, whereby the surface area of the inclined portion 33b of each of the protrusions 33 can be more easily increased.

According to the first embodiment, as hereinabove described, the substantially sectorial protrusions 33 each are formed to have a shape obtained by removing the annular protrusion 34 and the portion in the vicinity of the annular protrusion 34 from the sector broadening toward the radial outer side centering on the rotation center axis L of the disk rotating portion 40 in plan view, whereby the protrusions 33 are protrudable on a portion corresponding to a surface of the optical disk 100 from which a hole is removed in the vicinity of the rotation center axis L in a case where the rotated optical disk 100 is an optical disk 100 having the hole in the vicinity of the rotation center axis L, and hence the protrusions 33 are efficiently protrudable on the portion corresponding to the surface of the optical disk 100 from which the hole is removed in the vicinity of the rotation center axis L while increasing the surface area of each of the protrusions 33.

According to the first embodiment, as hereinabove described, the wall portion 33a of each of the protrusions 33 is formed to have a height at least half a distance between the lower surface 31a of the flat plate portion 31 of the top cover 30 and the upper surface (in the direction Z1) of the optical disk 100 in a thickness direction of each of the protrusions 33, whereby the flow of the air rotated together with the optical disk 100 can be easily caused to collide with the wall portion 33a in a case of rotating the optical disk 100, and hence the flow of the air can be more easily slowed in the vicinity of the wall portion 33a.

According to the first embodiment, as hereinabove described, the protrusions 33 are integrally formed on the top cover 30, whereby the number of components can be inhibited from increase.

### Second Embodiment

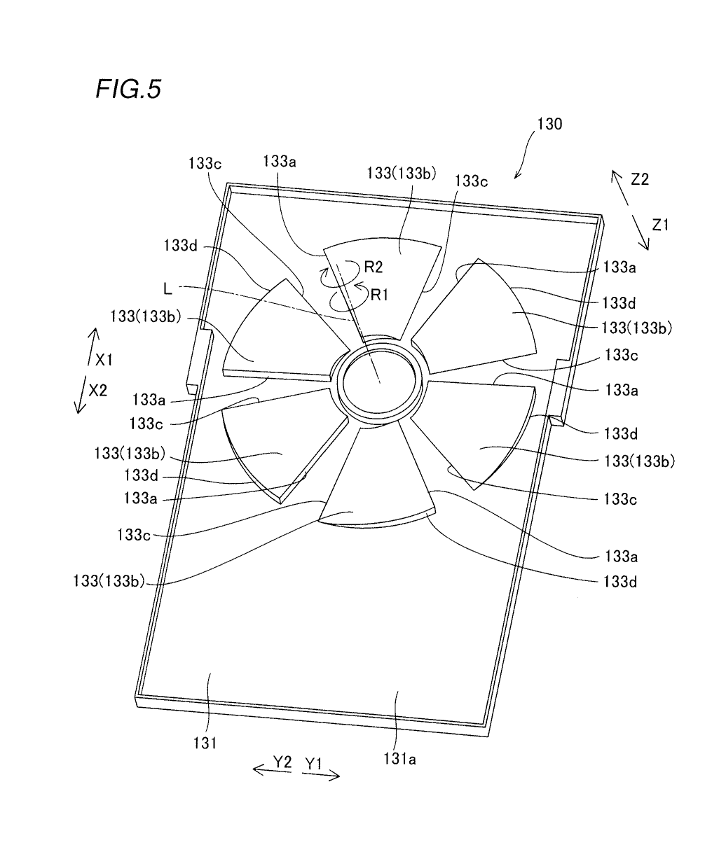

An optical disk device according to a second embodiment of the present invention is now described with reference to FIG. 5. In the optical disk device according to the second embodiment, protrusions 133 each having a thickness protruding from a lower surface 131a of a flat plate portion 131 toward an optical disk 100 which becomes smaller along a direction R2 opposite to a rotation direction R1 of a disk rotating portion 40 are provided, dissimilarly to the optical disk device 1 according to the aforementioned first embodiment in which the protrusions 33 each having a thickness protruding from the lower surface 31a of the flat plate portion 31 toward the optical disk 100 which becomes smaller along the rotation direction R1 of the disk rotating portion 40 are provided.

In the optical disk device according to the second embodiment, as shown in FIG. 5, a plurality of (six) the protrusions 133 on a top cover 130 each include a wall portion 133a formed on a side portion in the rotation direction R1 of the disk rotating portion 40, an inclined portion 133b with a thickness protruding toward the optical disk 100 (in a direction Z2) which becomes smaller as it goes in the direction R2 opposite to the rotation direction R1 of the disk rotating portion 40 centering on a rotation center axis L from the wall portion 133a, an end 133c formed on a side portion of the inclined portion 133b in the direction R2 opposite to the rotation direction R1 of the disk rotating portion 40 and an outer periphery 133d corresponding to an arc of a sector. In other words, the protrusions 133 each are formed to incline by reducing the thickness protruding from the lower surface 131a of the flat plate portion 131 toward the optical disk 100 (in the direction Z2) along the direction R2 opposite to the rotation direction R1 of the disk rotating portion 40. The wall portion 133a and the end 133c are examples of the “side portion” in the present invention.

The wall portion 133a of each of the protrusions 133 is formed to be substantially perpendicular to the direction R1 of flow of air rotated together with the optical disk 100 rotated by the disk rotating portion 40. The end 133c of each of the protrusions 133 is formed to coincide with a plane of the lower surface 131a of the flat plate portion 131 of the top cover 130.

The outer periphery 133d of each of the protrusions 133 is formed to extend arcuately centering on the rotation center axis L in plan view and extend in a direction substantially perpendicular to the flat plate portion 131 from the lower surface 131a of the flat plate portion 131 of the top cover 130. A height of the outer periphery 133d in the direction Z2 lowers along the direction R2 opposite to the rotation direction R1 of the disk rotating portion 40, similarly to inclination of the inclined portion 133b.

According to the second embodiment, as hereinabove described, the protrusions 133 each are formed to incline with respect to an upper surface (in a direction Z1) of the optical disk 100 by changing the thickness protruding from the lower surface 131a of the flat plate portion 131 of the top cover 130 toward the optical disk 100 (in the direction Z2) along the rotation direction R1 (the direction R2 opposite to the rotation direction R1) of the disk rotating portion 40, whereby the flow of the air rotated together with the optical disk 100 can be changed in a case of rotating the optical disk 100. Thus, flow of air between the upper surface (in the direction Z1) of the optical disk 100 and the lower surface 131a of the flat plate portion 131 of the top cover 130 can be inhibited from acceleration, and hence pressure resulting from acceleration of the flow of the air between the upper surface (in the direction Z1) of the optical disk 100 and the lower surface 131a of the flat plate portion 131 of the top cover 130 can be inhibited from decrease.

According to the second embodiment, as hereinabove described, the protrusions 133 each are so inclined that the thickness protruding from the lower surface 131a of the flat plate portion 131 of the top cover 130 toward the optical disk 100 (in the direction Z2) is gradually increased along the rotation direction R1 of the disk rotating portion 40, whereby a difference between high pressure and low pressure on the upper surface (in the direction Z1) of the optical disk 100 can be inhibited from increase as compared with the structure in which the protrusions 33 each are so inclined that the thickness protruding from the lower surface 31a of the flat plate portion 31 of the top cover 30 toward the optical disk 100 (in the direction Z2) is gradually reduced along the rotation direction R1 of the disk rotating portion 40. It has been confirmed from a simulation made by the inventors described later that the difference between the high pressure and the low pressure on the upper surface (in the direction Z1) of the optical disk 100 can be inhibited from increase.

The remaining structure and effects of the second embodiment are similar to those of the aforementioned first embodiment.

The results of the simulations performed for confirming the aforementioned effects obtained by employing the optical disk devices according to the first and second embodiments are now described in detail.

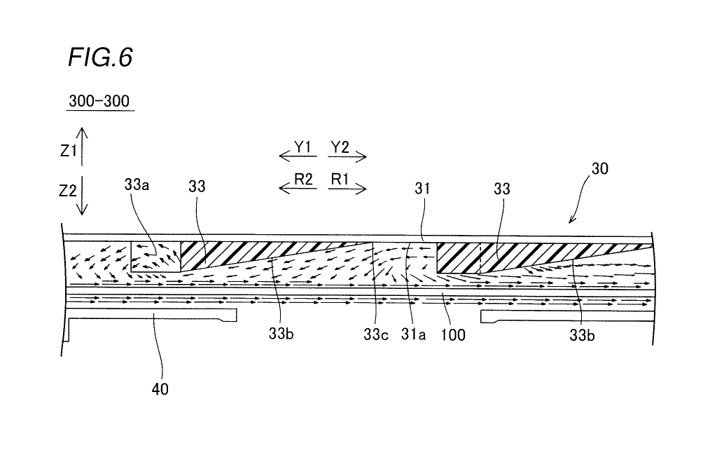

FIG. 6 is a sectional view showing the result of the simulation of flow of air in the vicinity of the optical disk 100 when rotating the optical disk 100 in the rotation direction R1 of the disk rotating portion 40.

As shown in FIG. 6, it is understood that air in the vicinity of both surfaces of the optical disk 100 is flowing in the direction R1 along with rotation of the optical disk 100 when the disk rotating portion 40 rotates the optical disk 100 in the direction R1. On the other hand, it is understood that the flow of the air rotated together with the optical disk 100 is colliding with the wall portion 33a of each of the protrusions 33 in the vicinity of the wall portion 33a of each of the protrusions 33 between the upper surface (in the direction Z1) of the optical disk 100 and the lower surface 31a of the flat plate portion 31 of the top cover 30. It is understood that the air colliding with the wall portion 33a turns around and is smoothly moved along the inclined portion 33b in the direction R2 opposite to the rotation direction R1 of the optical disk 100. As hereinabove described, the air moved in the direction R2 opposite to the rotation direction R1 of the optical disk 100 can conceivably inhibit the flow of the air in the vicinity of the optical disk 100 from acceleration.

The result of examining the effect of reducing flying force of the optical disk by providing the substantially sectorial protrusions using a simulation is now described with reference to FIGS. 2, 5 and 7 to 10.

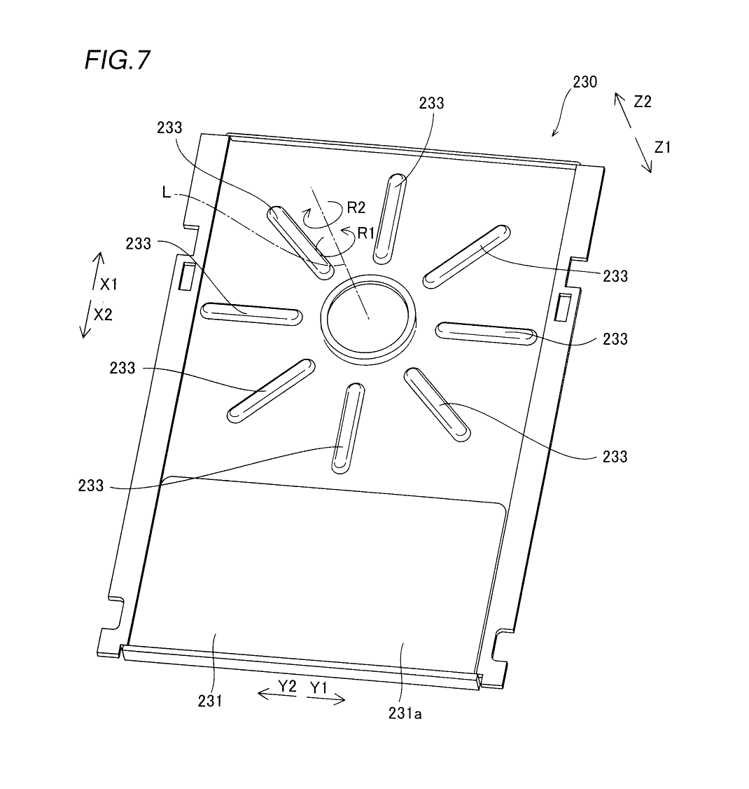

The simulation of flying force applied to the optical disk 100 rotated by the disk rotating portion 40 has been performed for respective models corresponding to the top cover 30 according to a first example corresponding to the structure of the first embodiment shown in FIG. 2, the top cover 130 according to a second example corresponding to the structure of the second embodiment shown in FIG. 5 and a top cover 230 according to a comparative example shown in FIG. 7.

In this simulation, the models of the top cover 30 according to the first example shown in FIG. 2 and the top cover 130 according to the second example shown in FIG. 5 were configured to be similar to the aforementioned respective structures of the first and second embodiments. The model of the top cover 230 according to the comparative example shown in FIG. 7 was configured to have a plurality of (eight) slender protrusions 233 extending from a portion closer to a rotation center axis L of a disk rotating portion 40 toward the radial outer side in plan view, as shown in FIG. 7. The protrusions 233 each were configured to protrude from a lower surface 231a of a flat plate portion 231 toward the disk rotating portion 40 (optical disk 100) (in a direction Z2). The plurality of (eight) protrusions 233 each were so configured that a thickness thereof was parallel to the flat plate portion 231.

As a result of the aforementioned simulation of flying force, flying force applied to the optical disk 100 rotated by the disk rotating portion 40 was 0.455 N in the model of the top cover 30 according to the first example. Further, flying force applied to the optical disk 100 rotated by the disk rotating portion 40 was 0.57 N in the model of the top cover 130 according to the second example while flying force applied to the optical disk 100 rotated by the disk rotating portion 40 was 0.78 N in the model of the top cover 230 according to the comparative example. In other words, it is understood that flying force applied to the optical disk 100 can be minimized in the aforementioned model of the first example. Further, it is understood that flying force applied to the optical disk 100 can be lowered in the model of the second example as compared with in the model of the comparative example.

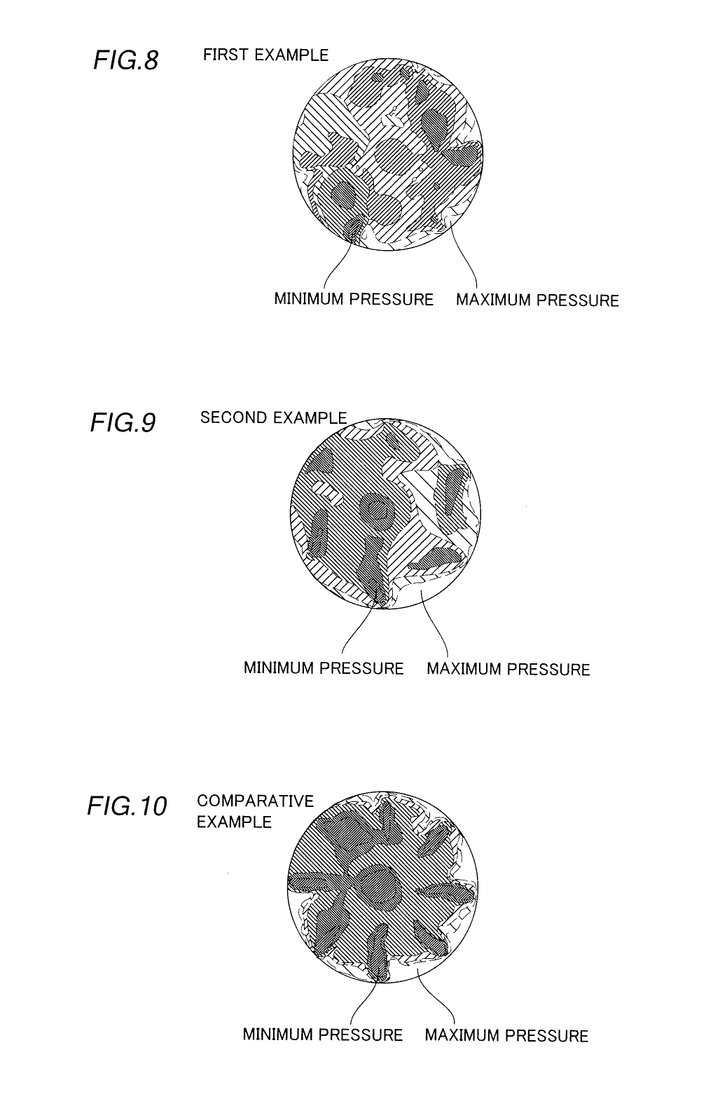

FIG. 8 is a diagram showing a distribution of pressure in the vicinity of the upper surface of the optical disk 100 in a case where the simulation of flying force applied to the optical disk 100 rotated by the disk rotating portion 40 is performed by employing the model of the top cover 30 according to the first example. FIG. 9 is a diagram showing a distribution of pressure in the vicinity of the upper surface of the optical disk 100 in a case where the simulation of flying force applied to the optical disk 100 rotated by the disk rotating portion 40 is performed by employing the model of the top cover 130 according to the second example. FIG. 10 is a diagram showing a distribution of pressure in the vicinity of the upper surface of the optical disk 100 in a case where the simulation of flying force applied to the optical disk 100 rotated by the disk rotating portion 40 is performed by employing the model of the top cover 230 according to the comparative example. The density of hatching on the distributions of pressure is increased as pressure is decreased.

As shown in FIG. 8, it is understood that the number of portions where pressure drastically drops is small and relatively high pressure is distributed over the surface of the optical disk 100 in the first example. In the second example, distribution showing a large difference between high pressure and low pressure is not seen whereas distribution of low pressure in comparison with the first embodiment is seen. Thus, deformation of the optical disk 100 due to a rapid change of pressure on the surface of the optical disk 100 can be inhibited from occurrence in each of the first and second examples.

In the comparative example, it is understood that pressure on portions opposed to the protrusions 233 is small. On the other hand, it is understood that pressure on portions opposed to the vicinities of outer edges of the optical disk 100 excluding the portions opposed to the protrusions 233 is large. More specifically, it is understood that a difference of pressure on portions opposed to the vicinities of the outer edges of the optical disk 100 is large. In other words, a deformation may be conceivably caused in the vicinities of the outer edges of the optical disk 100 in the comparative example. Further, it is understood that distributed pressure is small in the comparative example as compared with in the first and second examples.

Although the present invention has been described and illustrated in detail, it is clearly understood that the same is by way of illustration and example only and is not to be taken by way of limitation, the spirit and scope of the present invention being limited only by the terms of the appended claims.

For example, while the inclined portion is provided on a surface of each of the protrusions closer to the optical disk and is inclined with respect to the surface of the optical disk along the rotation direction of the disk rotating portion in each of the aforementioned first and second embodiments, the present invention is not restricted to this. The surface of each of the protrusions closer to the optical disk may alternatively be a flat surface substantially parallel to the surface of the optical disk.

While the protrusions each are formed by removing the annular protrusion and the portion in the vicinity of the annular protrusion from the sector broadening toward the radial outer side centering on the rotation center axis of the disk rotating portion in plan view in each of the aforementioned first and second embodiments, the present invention is not restricted to this. The protrusions each may alternatively be formed by a sector broadening toward the radial outer side centering on the rotation center axis of the disk rotating portion in plan view without providing the annular protrusion. In other words, the protrusions may alternatively be formed in an exactly sectorial shape in plan view.

While the six protrusions are provided in each of the aforementioned first and second embodiments, the present invention is not restricted to this. Five or less protrusions may alternatively be provided, or seven or more protrusions may alternatively be provided. The protrusions are preferably arranged centrosymmetrically.

While the top cover is made of resin in each of the aforementioned first and second embodiments, the present invention is not restricted to this. The top cover may alternatively be made of a material other than resin, such as a sheet metal, for example.

While the end of the inclined portion in the rotation direction of the disk rotating portion is formed to coincide with the plane of the lower surface of the flat plate portion of the top cover in the aforementioned first embodiment, the present invention is not restricted to this. The end of the inclined portion in the rotation direction of the disk rotating portion may not alternatively coincide with the plane of the lower surface of the flat plate portion of the top cover.

What is claimed is:

1. A disk device comprising:
a rotating portion holding a disk and rotating held said disk; and
a cover member provided to cover a surface of said disk at a prescribed interval from said surface of said disk when said disk is held by said rotating portion, wherein
said cover member includes a protrusion protruding from a lower surface of said cover member toward said disk, and
said protrusion has a substantially sectorial shape including a pair of side portions broadening from a portion closer to a rotation center axis of said rotating portion toward a radial outer side and an outer periphery in plan view.

2. The disk device according to claim 1, wherein
said protrusion is formed to incline with respect to said surface of said disk by changing a thickness protruding from said lower surface of said cover member toward said disk along a rotation direction of said rotating portion.

3. The disk device according to claim 2, wherein
said protrusion is formed to incline by slowly changing said thickness protruding from said lower surface of said cover member toward said disk along said rotation direction of said rotating portion.

4. The disk device according to claim 3, wherein
said protrusion is so inclined that said thickness protruding from said lower surface of said cover member toward said disk is gradually reduced along said rotation direction of said rotating portion.

5. The disk device according to claim 4, wherein
said protrusion has a wall portion formed on a side portion in a direction opposite to said rotation direction of said rotating portion and an inclined portion with a thickness protruding toward said disk which becomes smaller as it goes in said rotation direction of said rotating portion centering on said rotation center axis from said wall portion.

6. The disk device according to claim 5, wherein
said wall portion is formed to extend in a direction substantially perpendicular to said surface of said disk.

7. The disk device according to claim 5, wherein
a side portion of said inclined portion of said protrusion in said rotation direction of said rotating portion is formed to coincide with a plane of said lower surface of said cover member.

8. The disk device according to claim 3, wherein
said protrusion is so inclined that said thickness protruding from said lower surface of said cover member toward said disk is gradually increased along said rotation direction of said rotating portion.

9. The disk device according to claim 1, wherein
a plurality of said protrusions are provided, and
said plurality of protrusions are arranged centrosymmetrically with said rotation center axis of said rotating portion at a center in plan view.

10. The disk device according to claim 9, wherein
said plurality of protrusions are provided at a prescribed interval from each other, and
a width of each of said protrusions in a rotation direction of said rotating portion centering on said rotation center axis of said rotating portion is larger than said prescribed interval at the same radial position.

11. The disk device according to claim 10, wherein
said width of each of said protrusions in said rotation direction of said rotating portion centering on said rotation center axis of said rotating portion is at least twice said prescribed interval at the same radial position.

12. The disk device according to claim 1, wherein
said cover member further includes an annular protrusion protruding from said lower surface of said cover member toward said disk,
said annular protrusion has an annular shape centering on said rotation center axis of said rotating portion, and
substantially sectorial said protrusion is formed to have a shape obtained by removing said annular protrusion and a portion in the vicinity of said annular protrusion from a sector broadening toward the radial outer side centering on said rotation center axis of said rotating portion in plan view.

13. The disk device according to claim 12, wherein
said annular protrusion has a thickness larger than that of said substantially sectorial protrusion.

14. The disk device according to claim 5, wherein
said wall portion of said protrusion has a height at least half a distance between said lower surface of said cover member and said surface of said disk in a thickness direction of said protrusion.

15. The disk device according to claim 1, wherein
said protrusion is integrally formed on said cover member.
